(19) United States
(12) Patent Application Publication
(10) Pub. No.: US 2012/0267113 A1
(43) Pub. Date: Oct. 25, 2012

(54) TREATMENT OF OIL

(75) Inventors: Philip Fletcher, West Yorkshire (GB); Jeffrey Forsyth, Aberdeenshire (GB)

(73) Assignee: OILFLOW SOLUTIONS HOLDINGS LIMITED, Lancashire (GB)

(21) Appl. No.: 13/392,363

(22) PCT Filed: Aug. 24, 2010
(86) PCT No.: PCT/GB10/51392

§ 371 Date: Jul. 12, 2012

(30) Foreign Application Priority Data
Aug. 26, 2009 (GB) 0914839.6

(51) Int. Cl. C09K 8/588; E21B 43/12

(52) U.S. Cl. 166/310; 507/230

(57) ABSTRACT

A method of treating crude oil which comprises contacting the oil with a treatment fluid formulation comprising a polymeric material which comprises vinylalcohol repeat units, wherein said polymeric material is of a type which has a weight average molecular weight in the range 5,000 to 50,000 and/or wherein the viscosity of a 4 wt % aqueous solution of the polymeric material at 2° C. is in the range 1.5-7 cP. The oil may be contacted with the treatment fluid formulation underground by, for example, injection of the fluid formulation into an injection well or production well and the mobility of the oil contacted thereby is significantly improved.

This invention relates to the treatment of oil.

WO2005/040669 (Advanced Gel Technology) describes a method for reducing the viscosity of viscous fluids especially crude oil. The method involves addition of an aqueous formulation comprising optionally cross-linked 80-95 wt % hydrolysed polyvinylalcohol of molecular weight 110,000 (Eg 1), 300,000 (Eg 4) or 160,000 (Eg 8) to crude oil to reduce its viscosity and facilitate its passage along a fluid flow path to a desired location.

WO2005/100517 (Aubin) describes an improved method and additive for reducing the viscosity of crude oil. An additive comprising a high molecular weight polyvinylalcohol is contacted with the oil to achieve the viscosity reduction.

WO2006/106300 (Proflux) relates to maintaining and/or improving mobility of wax-containing fluids to facilitate their flow between two locations. The method involves use of high molecular weight polyvinylalcohol, for example of 300,000 as described in Example 1.

WO2008/053147 (Proflux) relates to a method of recovering oil from a subterranean formation which uses high molecular weight polyvinylalcohol, for example of 180,000, as described in Example 1.

WO2008/152357 (Proflux) discloses improving performance or efficiency of a well bore pump using a formulation comprising high molecular weights of polyvinylalcohol having a molecular weight of 180,000.

Although the aforementioned methods can be effective, in some cases, the viscosity of the oil may not be reduced sufficiently and/or its mobility may not be increased sufficiently to enable it to flow in a satisfactory manner. In any event, it is generally desirable to reduce the viscosity of the oil and/or increase its mobility as much as possible, to optimise the oil recovery rate. It is an object of preferred embodiments of the present invention to address this problem.

In the aforementioned methods, after a formulation comprising oil, water and polyvinylalcohol has been delivered to a desired location, the oil must be separated from the aqueous phase which comprises polyvinylalcohol and water. This may be achieved by reducing any mixing or turbulent movement of the oil and aqueous phase and allowing the mixture to settle to define respective oil and aqueous phases from which the components may be isolated. However, in some cases, relatively high levels of oil remain in the aqueous phase meaning that the amount of oil recovered is reduced and the aqueous phase is contaminated with significant quantities of oil meaning disposal of the aqueous phase in an environmentally-acceptable manner is more difficult. It is an object of preferred embodiments of the invention to address this problem.

According to a first aspect of the invention, there is provided a method of treating oil which comprises contacting the oil with a treatment fluid formulation comprising a polymeric material which comprises vinylalcohol repeat units, wherein said polymeric material is of a type which has a weight average molecular weight in the range 5,000 to 50,000 and/or wherein the viscosity of a 4 wt % aqueous solution of the polymeric material at 20° C. is in the range 1.5-7 cP.

Weight average molecular weight may be measured by light scattering, small angle neutron scattering, x-ray scattering or sedimentation velocity. The viscosity of the specified aqueous solution of the polymeric material may be assessed by Japanese Standards Association (JSA) JIS K6726 using a Type B viscometer. Alternatively, viscosity may be measured using other standard methods. For example, any laboratory rotational viscometer may be used such as an Anton Paar MCR300.

The weight average molecular weight of said polymeric material (Mw) may be less than 40,000, suitably, less than 30,000, preferably less than 25,000. The Mw may be at least 5000, preferably at least 10,000. The Mw is preferably in the range 5,000 to 25,000, more preferably in the range 10,000 to 25,000.

The viscosity of a said 4 wt % aqueous solution of the polymeric material at 20° C. may be at least 2.0 cP, preferably at least 2.5 cP. The viscosity may be less than 6 cP, preferably less than 5 cP, more preferably less than 4 cP. The viscosity is preferably in the range 2 to 4 cP.

The number average molecular weight (Mᵣ) may be at least 5,000, preferably at least 10,000, more preferably at least 13,000. Mₙ may be less than 40,000, preferably less than 30,000, more preferably less than 25,000. The Mₙ is preferably in the range 5,000 to 25,000.

Said polymeric material suitably comprises at least 50 mole %, preferably at least 60 mole %, more preferably at least 70 mole %, especially at least 80 mole % of vinylalcohol repeat units. It may comprise less than 99 mole %, suitably less than 95 mole %, preferably less than 91 mole % of vinylalcohol repeat units. Said polymeric material suitably comprises 60 to 99 mole %, preferably 80 to 95 mole %, more preferably 85 to 95 mole %, especially 80 to 91 mole % of vinylalcohol repeat units.

Said polymeric material preferably includes vinylacetate repeat units. It may include at least 2 mole %, preferably at least 5 mole %, more preferably at least 7 mole %, especially at least 9 mole % of vinylacetate repeat units. It may comprise 30 mole % or less, or 20 mole % or less of vinylacetate repeat units. Said polymeric material preferably comprises 9 to 20 mole % of vinylacetate repeat units.

Said polymeric material is preferably not cross-linked.

Suitably, the sum of the mole % of vinylalcohol and vinylacetate repeat units in said polymeric material is at least 80 mole %, preferably at least 90 mole %, more preferably at least 95 mole %, especially at least 99 mole %.

Said polymeric material preferably comprises 70-95 mole %, more preferably 80 to 95 mole %, especially 85 to 91 mole % hydrolysed polyvinylalcohol.

Said treatment fluid formulation is preferably aqueous. It suitably comprises at least 80 wt %, preferably at least 90 wt %, more preferably at least 95 wt %, especially at least 98 wt % water. It may include 99.5 wt % or less of water.

Said treatment fluid formulation suitably includes at least 0.1 wt %, preferably at least 0.3 wt %, more preferably at least 0.4 wt % of said polymeric material. It may include less than 1 wt %, preferably less than 0.8 wt % of said polymeric material.

Said treatment fluid formulation suitably includes 95 to 99 wt % of water, 0.1 to 1 wt % of said polymeric material and 0 to 3 wt % of other additives, such as biocides or corrosion inhibitors. The amount of other additives may be less than 2.5 wt %, suitably less than 2.0 wt %, preferably less than 1 wt %. Preferably, said treatment fluid formulation includes 98 to 99.9 wt % of water, 0.1 to 1 wt % of said polymeric material and 0 to 1 wt % of other additives.

In a preferred embodiment, said treatment fluid formulation comprises 98 to 99.9 wt % of water, 0.1 to 1 wt % of said polymeric material which is suitably not cross-linked and 0 to 1 wt % of other additives and said polymeric material comprises 85 to 91 mole % hydrolyzed polyvinylalcohol having a Mw in the range 5,000 to 30,000 and/or wherein the viscosity of a 4 wt % aqueous solution of the polymeric material at 20° C., suitably measured as described herein, is in the range 1.5 to 6 cP.

In an especially preferred embodiment, said treatment fluid formulation comprises 98 to 99.8 wt % of water, 0.2 to 1 wt % of said polymeric material which is not cross-linked and 0 to 1 wt % of other additives and said polymeric material comprises 85 to 91 mole % hydrolyzed polyvinylalcohol having a Mw in the range 10,000 to 30,000 and/or wherein the viscosity of a 4 wt % aqueous solution of the polymeric material at 20° C., suitably measured as described herein, is in the range 2 to 4 cP.

Said treatment formulation preferably include less than 0.5 wt %, more preferably less than 0.4 wt %, especially less than 0.2 wt % of other additives in the form of surfactants.

Said oil is preferably a crude oil which term in the context of the present specification includes tar (heavy crude oil), obtained from tar sands, and bitumen. The oil may have an API gravity of less than 30°, suitably less than 25°, preferably less than 20°. In some cases, the API gravity may be less than 15° or even less than 10°.

Said treatment fluid formulation could be initially contacted with oil at or near the surface, for example to facilitate transport of the oil in a pipeline. Preferably, said treatment fluid formulation is initially contacted with oil when the oil is underground. Preferably, said treatment fluid formulation is introduced into a subterranean formulation. It is suitably arranged to contact oil in or associated with said formation.

Said treatment fluid formulation may be at a temperature of at least ambient temperature immediately prior to introduction into the formation. Preferably, the temperature is above ambient temperature immediately prior to said introduction. It may be at least 5° C., preferably at least 10° C. above ambient temperature.

Said treatment fluid formulation suitably has a viscosity at 25° C. and 100 s⁻¹ of greater than 0.98 cP, suitably greater than 1 cP, preferably greater than 1.2 cP, especially greater than 1.5 cP. Said treatment fluid formulation preferably has a viscosity under the conditions described of not greater than 10 cP, preferably of 5 cP or less, more preferably of 2 cP or less.

Water for use in the treatment fluid formulation may be derived from any convenient source. It may be potable water, surface water, sea water, aquifer water, deionised production water and filtered water derived from any of the aforementioned sources. Said water is preferably a brine, for example sea water or is derived from a brine such as sea water. The references to the amounts of water herein suitably refer to water inclusive of its components, e.g. naturally occurring components such as found in sea water. Water may include up to 6 wt % dissolved salts but suitably includes less than 4 wt %, 2 wt % or 1 wt % or less of dissolved salts which are naturally occurring in the water.

The method preferably comprises collecting oil which has been contacted with said treatment fluid formulation. The material collected suitably comprises oil and treatment fluid formulation. The material collected suitably includes greater than 5 wt %, preferably greater than 10 wt %, more preferably greater than 20 wt %, especially greater than 30 wt % of oil. The material collected may comprise less than 1 wt %, or even less than 0.75 wt % of said polymeric material. The material collected may comprise greater than 30 wt %, greater than 40 wt % or greater than 50 wt % of water. The method may include the step of causing oil to separate from at least part of the treatment fluid formulation after collection. Separation may involve allowing an oil phase and water phase to settle from a mixture initially collected.

In a first embodiment, the treatment fluid formulation may be delivered underground. The method may include contacting oil in a formation with a treatment fluid formulation at a position upstream of a production well. The treatment fluid formulation may be introduced into a formation via an injection well. Said injection well may be selected from a vertical well, a deviated well or a horizontal well.

In some examples, treatment fluid formulation may be introduced into a plurality, suitably three or more, injection wells, suitably substantially concurrently.

Preferably, in said first embodiment, initial contact of oil in said formation by said treatment fluid formulation causes oil to move in a first direction, wherein suitably the oil contacted was not moving in said first direction prior to said initial contact. Preferably, initial contact of oil in said formation causes the speed of movement of the oil contacted to increase. For example, the oil may be trapped and therefore substantially stationary (except for molecular motion of the oil) prior to contact. After contact, oil may be caused to move and so its speed will be increased. Suitably after contact, oil travels substantially at the speed of the treatment fluid formulation with which it is associated. In some cases, gravity may act on the oil to move it towards the production well in which case oil may move to the production well under both gravity and the force applied by said treatment fluid formulation. In other embodiments, substantially the only force causing oil to move towards the production well may be supplied by said treatment fluid formulation.

Preferably, the treatment fluid formulation is arranged (e.g. by virtue of the pressure applied to it to introduce it into the formation) to carry oil towards the production well.

The subterranean formation may include a plurality of production wells via which oil which has been contacted with said treatment fluid formulation may be collected.

A said production well may be selected from a vertical well, a deviated well, a horizontal well, a multilateral well and a branched well.

The method of the first embodiment may be used after some oil has been removed from the formation by an alternative method. The method may include one step which comprises contacting oil in said formation with said treatment fluid formulation as described and another step which involves contacting the formation with a different formulation. Subsequent to contact with the different formulation, there may be a further step which comprises contacting oil in said formation with treatment fluid formulation as described. The aforementioned sequence of steps may be repeated one or more times. In one embodiment, said different formulation may comprise steam.

In the first embodiment, initial contact of oil in said formation with said treatment fluid formulation suitably takes place at a position which is at least 5 m, preferably at least 10 m, more preferably at least 50 m, especially at least 100 m, upstream of said production well although treatment fluid formulation could additionally contact some oil at positions closer to said production well. Initial contact suitably takes place a distance of at least 10 m, preferably at least 20 m below ground level. Said treatment fluid may travel at least 10 m, preferably at least 20 m before it contacts oil in said formation. After initial contact with said treatment fluid formulation, oil may travel at least 10 m, preferably at least 20 m, more preferably at least 50 m prior to reaching said production well.

In a second embodiment, the method may comprise improving performance or efficiency of a wellbore pump associated with a wellbore and/or for increasing the rate of production of reservoir fluid from a reservoir, wherein a wellbore pump is arranged to pump wellbore fluid within the wellbore to a surface, said method comprising the steps of:

(a) selecting a wellbore which includes an associated wellbore pump; and

(b) contacting a reservoir fluid upstream of an inlet of the wellbore pump with said treatment fluid formulation.

Use of the treatment fluid formulation appears to facilitate passage of reservoir fluid including oil through constrictions by lowering the surface tension and/or frictional forces between the reservoir fluid and walls which define constrictions. The walls may be of the near wellbore pores, residing in the reservoir; or may be walls of production tubing from the pump outlet to the surface; or may be walls of orifices of the pump inlet or outlet; or may be internal walls within pumps themselves; or may be within sand control barriers. Such reduced forces may facilitate passage of reservoir fluid and consequently may improve performance or efficiency of a pump associated with a wellbore. Furthermore, use of the treatment fluid formulation may advantageously allow the rate of flow of fluid passing from the reservoir into the wellbore to increase and consequently the barrels of oil per day (BOPD) may be increased which is economically and commercially very significant.

In one case, use of the treatment fluid formulation may simply reduce the torque on the wellbore pump. However, in a second case, the height of the head of reservoir fluid in a wellbore annulus may be lowered and, consequently, the back pressure due to the head will be reduced and the reservoir may then yield more oil. In a third case in which a wellbore includes an associated sand control barrier, use of the treatment fluid formulation may facilitate flow of oil through the barrier, reduce back pressure and the reservoir may therefore yield more oil. In a fourth case, the method may be used to increase the rate of production of a non-producing or “dry” well.

Said reservoir fluid suitably comprises oil, such as heavy oil. The method may advantageously be used to increase the rate of production of the aforementioned liquid hydrocarbons.

In step (b), said reservoir fluid is preferably initially contacted with said treatment formulation in said wellbore.

In one example of the second embodiment, said wellbore may have a maximum deviation in the range 0 to 60° or in the range 0 to 30° C. Said wellbore may extend substantially vertically. In another example, the invention may be used for increasing the rate of production of reservoir fluids from horizontal wells or wells by having wellbores which deviate more than 60°.

Prior to contact with said reservoir fluid in said second embodiment, said treatment fluid formulation is suitably above the surface of the ground in which said wellbore is defined. It may be contained within a receptacle. In step (b), said treatment fluid formulation is preferably caused to move from a first position, spaced from the inlet of the wellbore pump, towards a second position defined by the inlet of the wellbore pump. Said treatment fluid formulation is preferably arranged to move along a fluid flow path which extends within the wellbore (preferably within an annulus of the wellbore) on moving towards said second position. Preferably, said fluid flow path extends between a first region of the wellbore adjacent an upper end of the wellbore and a second region of the wellbore which is suitably below the first region, preferably at or adjacent said inlet of said pump. Preferably, substantially the entirety of said fluid flow path extends within the wellbore. Said fluid flow path may extend at least 10 m, preferably at least 30 m.

Preferably, in step b), a force is incident upon the treatment fluid formulation to cause it to move between said first and second positions. Said force could be provided, at least in part, by a pump means. Preferably, a major amount of said force is provided by gravity. Suitably, at least 60%, preferably at least 70%, more preferably at least 80%, especially at least 90% of said force is provided by gravity. In a preferred embodiment, treatment fluid formulation is introduced into said wellbore and allowed to fall under gravity thereby to move towards the wellbore pump. In this case, suitably, no pump means may be used to speed up flow of the treatment formulation within the wellbore.

In one example of the second embodiment, in step (b), said treatment fluid formulation may be initially contacted with reservoir fluid in the annulus of the wellbore. The treatment fluid formulation may, after initial contact, be allowed to fall under gravity and move towards the inlet of the wellbore pump. When the annulus does not include a packer (or other interruption therein), the treatment fluid formulation may be introduced at or adjacent the top of the annulus. When the annulus includes a packer (or other interruption), the treatment fluid formulation may be introduced beyond the packer so that it is free to move (suitably under gravity) towards the inlet of the wellbore pump. In this regard, a conduit may be defined through the packer (or other interruption) to allow treatment fluid formulation to traverse the packer.

Preferably, treatment fluid formulation is initially contacted with reservoir fluid at a position which is at least 5 m above the height of the inlet of the wellbore pump. If the wellbore includes more than one pump, the referenced pump is suitably the lowermost one.

In a second less preferred example of the second embodiment, a conduit for containing treatment fluid formulation may extend to a position adjacent the inlet of the pump for delivering formulation directly to a region around the inlet. The conduit may be terminated with a delivery device having a plurality, preferably a multiplicity, of outlets for directing streams of treatment formulation to the region around the inlet.

A filtration device, for example a sand control barrier, may be associated with the wellbore, upstream of the wellbore pump. The method may particularly advantageously be applied to such arrangements, potentially leading to an increase in BOPD of a well.

Said wellbore pump may be of any type. Preferably, said wellbore pump is selected from a progressing cavity pump (PCP) (also known as an eccentric screw pump), a beam pump (also known as a rod pump, walking beam pump and a suction rod pump) and a centrifugal pump for example an electrical submersible pump (ESP).

The method of the second embodiment may be used particularly advantageously with the aforementioned wellbore pumps because it may allow performance and/or efficiency of the pumps to be increased and/or may reduce wear and/or service intervals of the pumps.

Preferred pumps may, in some cases, be PCPs or beam pumps. However, in some cases, the invention may advantageously be applied to situations wherein EPSs are associated with wellbores. ESPs are generally relatively cheap but are not generally usable to transport heavy oils. However, use of the present invention may enable such pumps to be used, even to transport relatively heavy oils to the surface.

In a third embodiment, it may be preferred for said treatment fluid formulation to initially contact the oil at or downstream of a producing face of a subterranean formation. Said method is suitably for treating oil which is arranged to flow along a fluid flow path. Said fluid flow path is preferably defined by a conduit means. Said conduit means preferably includes a first conduit part (e.g. a pipeline) which is arranged downstream of a production means, preferably above ground level. Said first conduit part preferably contains said oil after contact with the treatment fluid formulation.

Said fluid flow path (e.g. said conduit means) may extend between a first point, remote from the point of production of the viscous composition, and a second point closer to, for example at or adjacent to, the point of production of the viscous composition. Said first point may be above ground and may be, for example, a well-head or a refinery; said second point may be closer to the producing face of a subterranean formation. It may be at or adjacent to the producing face.

Said fluid flow path may be defined, in part, by a second conduit part which extends upwardly from below ground to above ground. Said second conduit part may be a riser pipe. Said second conduit part may contain oil after contact with the treatment fluid formulation.

Preferably, flow of said treatment fluid formulation is turbulent at the point of initial contact of said oil with said treatment fluid formulation so that said oil is dispersed and/or emulsified on contact with said formulation.

In the method, a delivery flow path is preferably defined which is arranged to communicate with said fluid flow path wherein said treatment fluid formulation is dosed into said oil in said fluid flow path via said delivery flow path. Said delivery flow path preferably communicates with said fluid flow path at or downstream of a producing face of the subterranean formation.

The ratio of the flow rate (in weight per unit time) of treatment fluid formulation in said delivery flow path to the flow rate (in the same units) of oil in said fluid flow path may be in the range 0.1 to 2.5, preferably in the range 0.2 to 1, more preferably in the range 0.4 to 0.8, especially in the range 0.6 to 0.7.

The mass fraction of oil in said fluid flow path after contact with said treatment fluid formulation, (for example at a time 1 to 2 hours after initial contact of oil with said treatment fluid formulation) may be in the range 0.1 to 0.9, and is preferably in the range 0.4 to 0.8.

Preferably, after contact between said oil and said treatment fluid formulation (for example at a time 1 to 2 hours after initial contact of oil with said treatment fluid formulation), the composition in said fluid flow path includes 10 to 80 wt % (suitably 30 to 80 wt %, preferably 40 to 80 wt %, more preferably 50 to 70 wt %) of material derived from said oil and 20 to 90 wt %, (suitably 20 to 70 wt %, preferably 20 to 60 wt %, more preferably 30 to 50 wt %, especially 30 to 45 wt %) of material derived from said treatment fluid formulation.

Suitably, after contact between said oil and said treatment fluid formulation (for example at a time 1 to 2 hours after initial contact of oil with said treatment fluid formulation), the composition in said fluid flow path includes at least 20 wt %, preferably at least 25 wt %, more preferably at least 30 wt %, water; and at least 20 wt %, suitably at least 40 wt %, preferably at least 50 wt %, more preferably at least 55 wt % of oil.

The amount of water in the composition in said fluid flow path immediately after contact between said oil and said treatment fluid formulation (for example at a time 1 to 2 hours after initial contact of oil with said treatment fluid formulation) is preferably less than 70 wt %, more preferably less than 60 wt %, especially less than 50 wt %, more preferably 40 wt % or less. The amount of water may be in the range 20 to 50 wt %.

In a fourth embodiment, the treatment fluid formulation may be used in a method for enhancing recovery of a petroleum product from an oilfield reservoir that includes at least one of heavy oil or bitumen. The treatment fluid formulation may be injected into a mobile water film within the oilfield reservoir to precondition the reservoir prior to production of the oil from the oilfield reservoir.

The treatment fluid formulation may be injected into an oil-rich zone in the reservoir. The treatment fluid formulation may be injected at a pressure low enough so that the heavy oil or bitumen is substantially unmoved by the injected treatment fluid formulation. The treatment fluid formulation can be allowed a defined period of time to permeate and react within the oil-rich zone prior to production. The treatment fluid formulation may be injected at a first location through a first well, and water can be produced from the reservoir at a second location from a second well to urge movement of the treatment fluid formulation in a direction from the first location toward the second location. After preconditioning the reservoir, the oil can be recovered from the reservoir by using cold production or a thermal recovery process, or both.

Preconditioning the oilfield reservoir may include modifying the viscosity of the oil in the reservoir using the treatment fluid formulation.

The fourth embodiment may use the treatment fluid formulation in preconditioning as described in WO2008/070990.

According to a second aspect of the invention, there is provided a system for use in the method of the first aspect, wherein the system is associated with a subterranean oil-bearing formation, the system comprising:

a receptacle containing a treatment fluid formulation comprising a polymeric material which comprises vinylalcohol repeat units, wherein said polymeric material is of a type which has a weight average molecular weight in the range 5,000 to 50,000 and/or wherein the viscosity of a 4 wt % aqueous solution of the polymeric material at 20° C. is in the range 1.5-7 cP; and

conduit means extending from the receptacle and being arranged to deliver said treatment fluid formulation from the reservoir to a position wherein it contacts oil associated with the subterranean oil-bearing formation.

The system may include means for collecting fluid after contact with oil and for effecting separation of the oil from the treatment fluid formulation.

Any feature of any aspect of any invention or embodiment described herein may be combined with any feature of any aspect of any other invention or embodiment described herein mutatis mutandis.

Specific embodiments of the invention will now be described, by way of example, with reference to the accompanying drawings, in which:

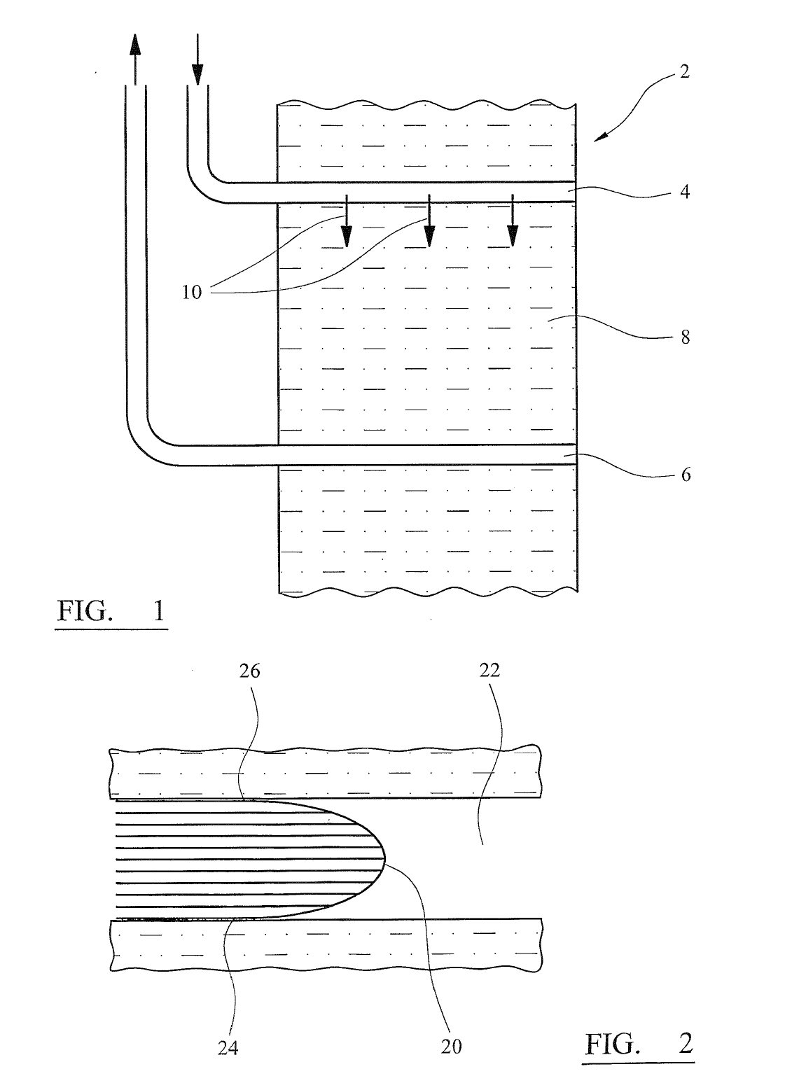

FIG. 1 is a diagrammatic cross-section through a subterranean oil-bearing formation;

FIG. 2 is a diagrammatic representation of treatment fluid moving through a pore in a subterranean oil-bearing formation;

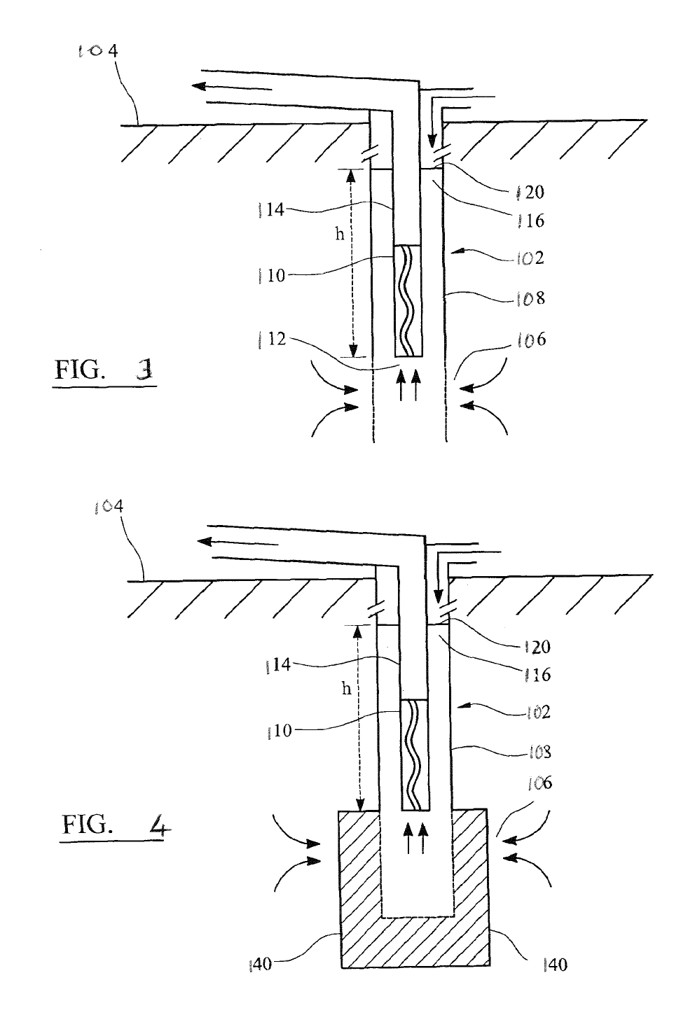

FIG. 3 is a schematic representation of an oil well; and

FIG. 4 is a view similar to that of FIG. 1 except the well includes a sand pack.

The following are referred to hereinafter:

Polyvinylalcohol Grade A—87-89 mole % hydrolyzed polyvinylalcohol, wherein the viscosity of a 4 wt % aqueous solution at 20° C. is 3-3.7 cP. This corresponds to a weight average molecular weight of about 20,000.

Polyvinylalcohol Grade B (comparative)—87-89% hydrolysed polyvinylalcohol, wherein the viscosity of 4 wt % aqueous solution at 20° C. is 45-55 cP which corresponds to a weight average molecular weight of about 180,000.

It has been found that low molecular weight polyvinylalcohol aqueous solutions can be advantageously used in a variety of treatments of crude oil to lower the viscosity of the oil and/or increase its mobility.

Example 1 describes preparation of polyvinylalcohol aqueous solutions, Example 2 describes preparation of oil dispersions and Examples 3 to 6 describe assessments undertaken on the dispersions of Example 2. The low molecular weight polyvinylalcohol may be used in a variety of applications as described hereinafter.

### EXAMPLE 1

### Preparation of Polyvinylalcohol Aqueous Solutions

0.5 wt % solutions of polyvinylalcohol grades A and B (comparative) were prepared by dissolution of the powdered polyvinylalcohol in water at an elevated temperature with stirring to produce a concentrate which was then diluted to produce the target concentration.

### EXAMPLE 2

### Preparation of Dispersions

Dispersions of a heavy crude oil (70 wt %) (API gravity=13, viscosity 17,000 cP at 25° C. and 7,000 cP at 35° C.) and the polyvinylalcohol solutions (30 wt % of the 0.5 wt % solutions) of Example 1 were prepared by mixing the polyvinylalcohol solutions with the oil in a sealed jar and then shaking the jar fifty times by hand. The dispersions were assessed as described in Examples 3 to 6.

### EXAMPLE 3

### Assessment of Viscosity of Dispersions

The viscosities of the dispersions of Example 2 were assessed using an Anton Paar MCR 300 rotational rheometer, equipped with a parallel plate sensor, at 35° C. and 100 s⁻¹.

### EXAMPLE 4

### Assessment of Dispersion Particle Size Distribution (PSD)

The PSD of the dispersion was measured with a Malvern Instruments Mastersizer 2000 using a laser light scattering technique. The mass mean diameter D(0.5) value in microns was reported. The D(0.5) is the particle size at which 50% of the particles are larger and 50% of the particles are smaller.

### EXAMPLE 5

### Assessment of Interfacial Tension (IFT)

IFT was measured using a Krüss Drop Shape Analyzer (DSA) 100 instrument using the pendant drop method. For the oils tested, this technique uses a J shaped needle, containing the test oil, to form a pendant drop in an aqueous polymer solution. The DSA software captures a digital image of the drop for processing and calculation of the IFT value.

### EXAMPLE 6

### Assessment of Water Quality After Settling of Dispersions

Dispersions of heavy crude oil (70 wt %) (API gravity=12, viscosity at 2.5° C. is 20,000 cP) and the polyvinylalcohol solutions (30 wt % of the 0.5 wt % solution) of Example 1 were prepared and subsequently allowed to settle over a period of 24 hours at 35° C. The clarity and cleanliness of the respective water phases were assessed.

Results

Results of the assessments of Examples 3 to 5 are provided in the table below.

| | | Dispersion | Interfacial |
|---|---|---|---|
| Polyvinylalcohol | Dispersion PSD of | Viscosity 35° C. | Tension |
| used | (0.5) | (100 s⁻¹) | Oil Solution |
| Grade A | 74.3 μm | 132 cP | 8.9 mN/m |
| Grade B | 141.6 μm | 179 cP | 13.71 mN/m |

It will be noted that the low molecular weight grade has a smaller PSD, a lower dispersion viscosity and a lower interfacial tension and has been found (in other field trials) to enhance mobility of oil and/or its recovery compared to when higher molecular weight grades of polyvinylalcohol are used.

Although in Example 6 clarity and cleanliness were only assessed visually, it was observed that the water phase for Grade A was significantly clearer and clean compared to that for the higher molecular weight Grade B.

In addition to advantages in use, in enhancing mobility of oil and/or its recovery, the viscosity of a solution of Grade A is significantly less than that of Grade B which may facilitate its use, for example its penetration into subterranean formations. Furthermore, it is easier to disperse Grade A in water to produce aqueous formulations.

Polyvinylalcohol Grade A has been used in several field trials and has been found to be very effective and provides advantages over use of other grades, such as higher molecular weight Polyvinyl alcohol Grade B. Grade A may be used in the areas discussed further below.

In a first embodiment, the polyvinylalcohol may be used as described in WO2005/040669 (although it is suitably not cross-linked), the content of which is incorporated herein by reference. As described in the document, heavy crude oil (and associated material) which may be too viscous to enable it to be pumped from the flowing face of a reservoir into and along a pipeline, for example to a refinery or other storage facility, may be contacted with a formulation comprising the polyvinylalcohol at any point where it is desirable to reduce the oil viscosity. For example, it may be dosed in at the bottom of a riser pipe to reduce the viscosity of oil flowing upwardly in the pipe. Alternatively, it may be dosed in at or near the surface. Once dosed in, the oil may be transported long distances through a pipeline to a refinery or other oil storage facility. After completion of the transport stage, it is necessary to recover the oil from the emulsion. This may be achieved by allowing the mixture to settle; by mechanical means or by chemical means.

In a second embodiment, the polyvinylalcohol may be used as described in WO2006/106300 (although it is suitably not cross-linked), the content of which is incorporated herein by reference. In the embodiment, wax-containing crude oils may be treated with the polyvinylalcohol, suitably after a pre-treatment comprising conventional inhibitors and/or solvents.

In a third embodiment, the polyvinylalcohol may be used as described in WO2008/053147, the content of which is incorporated herein by reference. Referring to FIG. 1, a subterranean oil bearing formation 2 includes a horizontal injection well 4 which is vertically spaced from a production well 6 with oil bearing formation 8 extending therebetween. The formation 8 may include medium or heavy oil, for example having a API of less than about 30° or less than 23° and/or a viscosity measured at 25° C. in excess of 1000 cP. The formation 2 may have a permeability of for example 1-6 Darcy.

Oil in the formation 2 may be present in a number of different forms. For example, discrete oil globules may be present in relatively large pores in the rock of the formation. Additionally, oil may be loosely adsorbed on rock surfaces. Also, oil may be present in microcapillaries.

To recover oil from the formation 2, a treatment fluid may be injected into the formation via injection well 4 so that it enters the formation as represented by arrows 10. The treatment fluid comprises a 0.1 to 2 wt % aqueous solution of polyvinylalcohol Grade A. After entering the formation, the treatment fluid will slowly move downwardly under gravity and permeate the formation. As it moves, the formulation is able to strip small amounts of oil from any oil it contacts and disperse and/or emulsify it.

Referring to FIG. 2, treatment fluid 20 is shown flowing through a pore 22 which may have a diameter of the order of 10 μm. The fluid exhibits lamina flow. As a result, the velocity of the fluid is highest along outermost laminars (e.g. 24, 26). So, when the fluid flows past oil, for example adsorbed on a rock surface, it may strip layers of the oil from the surface. Additionally when it passes an oil globule it may strip oil from the globule. Furthermore, as it may contact oil at an opening of a microcapillary, it may strip oil from the microcapillary. Thus, the treatment fluid may gradually erode areas of oil which it contacts. Furthermore, the treatment fluid is able to disperse and/or emulsify oil which is eroded/stripped as aforesaid. More particularly, the poly(vinylalcohol) is able to coat particles of the oil, thereby preventing such particles coalescing and allowing them to disperse in water.

In a fourth embodiment, the polyvinylalcohol may be used as described in WO2008/152357, the content of which is incorporated herein by reference. Referring to FIG. 3, an oil well includes a wellbore 102, below ground level 104, which extends to an oil reservoir 106. The wellbore includes a casing 108 within which is arranged a progressing cavity pump (PCP) 110 which includes an inlet 112 at its lower end and is connected at its upper end to production tube 114. An annulus 116 is defined between the pump 110/tube 114 and the casing 18. The annulus communicates with the reservoir and includes a head 120 of reservoir fluid. A water based formulation comprising a 0.5 wt % aqueous solution of a 88% hydrolysed polyvinylalcohol having a molecular weight of 20,000 can be poured down the annulus 116 and pass under gravity to the reservoir 106, immediately upstream of inlet 112. The formulation may improve the performance and efficiency of the pump 110 due to its ability to increase the mobility of the oil in the reservoir immediately upstream of the pump 110 and/or enhance the ability of the oil to enter the pump inlet. Furthermore, by improving mobility and/or reducing the level of back pressure when the oil enters the pump inlet (or any other constriction) the rate of flow of oil from the reservoir into the wellbore may be increased resulting in an increased rate of oil production.

In a variation on the FIG. 3 embodiment, a wellbore may include an associated sand control barrier 140 as shown in FIG. 4. The sand control barrier effectively filters sand particles from oil as oil passes from the reservoir into the wellbore to prevent such sand particles passing into pump 110 and passing to the surface. However, the sand control barrier acts as a constriction to the passage of oil into the wellbore, since the oil must pass through the openings of the sand control barrier to enter the wellbore.

The arrangement of FIG. 4 may be treated with the water-based formulation as described for Example 1. In this case, it is found that the performance and/or efficiency of pump 110 may be improved, and the rate of oil production may also be increased.

The use of the treatment formulation is believed to facilitate passage of reservoir fluid including oil through orifices (or other constrictions) for example through pump inlets and sand packs by reducing surface tension of the oil and/or interfacial tension between the oil and walls which define constrictions. By reducing the effective friction between the oil and walls which define constrictions, the oil may more easily pass through the constrictions into the wellbore and/or pump. As a result, the rate of flow of oil from the reservoir into the wellbore may be increased and/or the efficiency of wellbore pumps may be improved, potentially allowing pump speeds to be increased.

In a fifth embodiment, an aqueous formulation of Grade A may be used for pre-conditioning an oilfield reservoir as described in WO2008/070990, the content of which is incorporated herein by reference.

1. A method of treating oil which comprises contacting the oil with a treatment fluid formulation comprising a polymeric material which comprises vinylalcohol repeat units, wherein said polymeric material is of a type which has a weight average molecular weight in the range 5,000 to 50,000 and/or wherein the viscosity of a 4 wt % aqueous solution of the polymeric material at 20° C. is in the range 1.5-7 cP.

2. The method of claim 1, wherein the weight average molecular weight (Mw) of said polymeric material is in the range 5,000 to 25,000 and/or said viscosity is in the range 2 to 4 cP.

3. The method of claim 1, wherein said polymeric material comprises at least 50 mole % of vinylalcohol repeat units.

4. The method of claim 1, wherein said polymeric material comprises 80-95 mole % vinylalcohol repeat units.

5. The method of claim 1, wherein said polymeric material includes at least 2 mole % vinylacetate repeat units.

6. The method of claim 1, wherein said polymeric material comprises 70-95 mole % hydrolysed polyvinylalcohol.

7. The method of claim 1, wherein said treatment fluid formulation includes 95-95 wt % of water, 0.1 to 1 wt % of said polymeric material and 0 to 3 wt % of other additives.

8. The method of claim 1, wherein said treatment fluid formulation comprises 98 to 99.9 wt % of water, 0.1 to lwt% of said polymeric material and 0 to 1 wt % of other additives and said polymeric material comprises 85 to 91 mole % hydrolyzed polyvinylalcohol having a weight average molecular weight (Mw) in the range 5,000 to 30,000 and/or wherein the viscosity of a 4 wt % aqueous solution of the polymeric material at 20° C., is in the range 1.5 to 6 cP.

9. The method of claim 1, wherein said oil is a crude oil.

10. The method of claim 1, wherein said treatment fluid formulation is initially contacted with oil when the oil is underground.

11. The method of claim 1, wherein said treatment fluid formulation has a viscosity at 25° C. and 100s-1 of 10 cP or less.

12. The method of claim 1, which comprises collecting oil which has been contacted with said treatment fluid formulation, wherein said material collected includes greater than 20 wt % of oil and less than 1 wt % of said polymeric material, wherein the material collected comprises greater than 30 wt % of water, and the method includes the step of causing oil to separate from at least part of the treatment fluid formulation after collection.

13. The method of claim 1, wherein said treatment fluid formulation is delivered underground.

14. The method of claim 1, wherein
(i) the method includes contacting oil in a formation with a treatment fluid formulation at a position upstream of a production well, wherein the treatment fluid formulation is introduced into a formation via an injection well; or
(ii) the method comprises improving performance or efficiency of a well-bore pump associated with a well-bore and/or increasing the rate of production of reservoir fluid from a reservoir, wherein a wellbore pump is arranged to pump wellbore fluid within the wellbore to a surface, said method comprising the steps of:
(a) selecting a wellbore which includes an associated wellbore pump; and
(b) contacting a reservoir fluid upstream of an inlet of the wellbore pump with said treatment fluid formulation; or
(c) the method comprises said treatment fluid formulation initially contacting oil at or downstream of a producing face of a subterranean formation.

15. The method of claim 1, wherein said treatment fluid formulation comprises water derived from a subterranean formation at or adjacent a subterranean formation from which oil treated in the method is derived.

16. A system for use in the method of claim 1, wherein the system is associated with a subterranean oil-bearing formation, the system comprising:
a receptacle containing a treatment fluid formulation comprising a polymeric material which comprises vinylalcohol repeat units, wherein said polymeric material is of a type which has a weight average molecular weight in the range 5,000 to 50,000 and/or wherein the viscosity of a 4 wt % aqueous solution of the polymeric material at 20° C. is in the range 1.5-7 cP; and
conduit means extending from the receptacle and being arranged to deliver said treatment fluid formulation from the reservoir to a position wherein it contacts oil associated with the subterranean oil-bearing formation.

17. A treatment fluid formulation for use in the method of claim 1, said formulation comprising water derived from a subterranean formation which contains oil, said treatment fluid formulation comprising a polymeric material which comprises vinylalcohol repeat units, wherein said polymeric material is of a type which has a weight average molecular weight in the range 5,000 to 50,000 and/or wherein the viscosity of a 4 wt % aqueous solution of the polymeric material at 20° C. is in the range 1.5-7 cP.

18. The formulation of claim 16, which comprises at least about 0.1 wt % less than about 5 wt % of crude oil.

19. (canceled)

20. The formulation of claim 16, wherein the Mw of the polymeric material is between about 5,000 and about 25,000 and/or the viscosity is between about 2 and about 4 cP.
